(19) United States
(12) Patent Application Publication
(10) Pub. No.: US 2025/0065904 A1
(43) Pub. Date: Feb. 27, 2025

(54) AUTONOMOUS VEHICLE INFRASTRUCTURE HUB

(71) Applicant: TORC Robotics, Inc., Blacksburg, VA (US)

(72) Inventor: Justin CHONG, Blacksburg, VA (US)

(73) Assignee: TORC Robotics, Inc., Blacksburg, VA (US)

(21) Appl. No.: 18/238,433

(22) Filed: Aug. 25, 2023

(51) Int. Cl. B60W 60/00; G06V 20/54; G06V 20/56

(52) U.S. Cl. CPC B60W 60/001; G06V 20/54; G06V 20/56; B60W 60/0015; B60W 2300/12; B60W 2420/403; B60W 2420/408; G06V 2201/08

(57) ABSTRACT

A system including a supervisory computing device and a sensor apparatus positioned at a drivable intersection, the sensor apparatus remote from an autonomous vehicle and in communication with the autonomous vehicle. The sensor apparatus includes one or more sensors and one or more processors configured to receive from the sensors an indication of a presence of the autonomous vehicle at the drivable intersection and alert the supervisory computing device of the presence of the autonomous vehicle. The processors then receive a signal associated with a drivable area on which the autonomous vehicle may travel and predict a drivable path for the autonomous vehicle. The processors transmit an indication of the drivable path to the supervisory computing device to request approval to travel the drivable path. Upon receiving approval, the one or more processors transmit a signal to adjust an operating parameter to initiate travelling on the drivable path.

### TECHNICAL FIELD

The present disclosure relates generally to autonomous vehicles and, more specifically, to systems and methods for autonomous vehicle operation.

### BACKGROUND

The use of autonomous vehicles has become increasingly prevalent in recent years, with the potential for numerous benefits, such as improved safety, reduced traffic congestion, and increased mobility for people with disabilities. Autonomous vehicles, or self-driving vehicles, are designed to sense their environment and navigate without human input. Equipped with various sensors such as radar, LiDAR, GPS, odometry, and computer vision, these vehicles aim to identify suitable navigation paths, detect obstacles, and follow traffic laws.

Despite considerable advancements in this field, existing systems still face significant challenges in entering an intersection safely. In addition, existing systems also face significant challenges in determining viable locations for autonomous vehicle hub infrastructure.

### SUMMARY

Therefore, there is a need for an improved system and method that can accurately aid autonomous vehicles in initiating and executing an entrance into an intersection safely. Further, there is a need for an improved system and method for accurately determining the viability of a location for an autonomous vehicle hub.

According to an exemplary embodiment of the present disclosure, an intersection analysis system may include several components to (1) aid autonomous vehicles enter an intersection safely and (2) accurately determine the viability of an autonomous vehicle hub infrastructure.

In one embodiment, the intersection analysis system may include a sensor rig located at, or near, an intersection of interest (e.g., entrance/exit of an autonomous vehicle hub). The sensor rig may include a sensor suite attached at, or near, the top of a vertical mast of the sensor apparatus so as to provide a clear perception view of the intersection of interest and the surrounding area. The sensor rig may include one or more sensors designed to receive and transmit signals related to the intersection of interest (e.g., image data, LiDAR data, sonar data, radar data, etc.). In one embodiment, the one or more sensors in the sensor suite positioned at the top of the sensor rig scan the intersection of interest and the surrounding environment to determine the presence of objects (e.g., cars, pedestrians, bicyclists, cones, barriers, animals, road conditions, etc.). The sensor rig perceives the presence of an autonomous vehicle waiting to enter the intersection of interest. Upon perceiving the autonomous vehicle, the sensor rig communicates to a remote mission control center the presence of the autonomous vehicle. This alerts the remote operators of an impending decision to be made, thus allowing the operators to stand alert and ready to provide approval of a recommended entrance event.

After the sensor rig alerts the mission control of the presence of the vehicle, the sensor rig scans the intersection and surrounding area and inputs the collected data into a model/simulation for a safe opening for the autonomous vehicle to use in entering the intersection. One or more processors of the sensor rig digest the information gathered by the sensor suite of the sensor rig to identify an opening for the autonomous vehicle to use in entering the intersection.

Once an opening is identified, the sensor rig communicates the recommended opportunity to the mission control. A supervisory operator receives the recommended opportunity and chooses to approve or reject the opportunity. This decision (to approve or reject) is communicated back to the sensor rig which then communicates the decision to the autonomous vehicle. In some embodiments, the mission control decision is communicated directly to the autonomous vehicle. In other embodiments, the sensor rig communicates recommended opportunities to the vehicle directly without the intermediary mission control.

According to one implementation of the present disclosure, a system includes: a supervisory computing device; and a sensor apparatus positioned at a drivable intersection, the sensor apparatus remote from an autonomous vehicle and in communication with the autonomous vehicle and including: one or more sensors configured to receive a sensor signal associated with the drivable intersection; and one or more processors configured to: receive, from the one or more sensors, an indication of a presence of the autonomous vehicle at the drivable intersection associated with the sensor apparatus; alert the supervisory computing device of the presence of the autonomous vehicle at the drivable intersection; receive, from the one or more sensors, a signal associated with a drivable area on which the autonomous vehicle may travel; predict a drivable path for the autonomous vehicle entering the drivable intersection; transmit, to the supervisory module, an indication of the drivable path; request, from the supervisory computing device, an approval for the autonomous vehicle to adjust an operating parameter to travel on the drivable path in view of other vehicles at the drivable intersection; receive, from the supervisory computing device, the approval to adjust the operating parameter to travel on the drivable path; and upon receiving the approval, transmit to an electronic control unit of the autonomous vehicle, a control signal to adjust the operating parameter to initiate travelling on the drivable path.

According to an embodiment, the sensor apparatus includes one or more sensors used on the autonomous vehicle.

According to an embodiment, the sensor apparatus is permanently installed proximate the drivable intersection.

According to an embodiment, the one or more sensors include at least one of a camera, a LiDAR sensor, a radar sensor, and a sonar sensor.

According to an embodiment, the one or more processors predict the drivable path by inputting at least the signal associated with the drivable area into a simulation model.

According to an embodiment, the supervisory computing device is located at a mission control headquarters remote to the sensor apparatus and the autonomous vehicle and operated by a user.

According to an embodiment, the sensor apparatus is used for testing new sensors for the autonomous vehicle

According to an implementation of the present disclosure, a sensor apparatus positioned at a drivable intersection, the sensor apparatus remote from an autonomous vehicle and in communication with the autonomous vehicle and including: one or more sensors configured to receive a sensor signal associated with the drivable intersection; and one or more processors configured to: receive, from the one or more sensors, an indication of a presence of the autonomous vehicle at the drivable intersection associated with the sensor apparatus; alert a supervisory computing device of the presence of the autonomous vehicle at the drivable intersection; receive, from the one or more sensors, a signal associated with a drivable area on which the autonomous vehicle may travel; predict a drivable path for the autonomous vehicle entering the drivable intersection; transmit, to a supervisory module, an indication of the drivable path; request, from the supervisory computing device, an approval for the autonomous vehicle to adjust an operating parameter to travel on the drivable path in view of other vehicles at the drivable intersection; receive, from the supervisory computing device, the approval to adjust the operating parameter to travel on the drivable path; and upon receiving the approval, transmit to an electronic control unit of the autonomous vehicle, a control signal to adjust the operating parameter to initiate travelling on the drivable path.

According to an embodiment, the sensor apparatus includes one or more sensors used on the autonomous vehicle.

According to an embodiment, the sensor apparatus is permanently installed proximate the drivable intersection.

According to an embodiment, the one or more sensors include at least one of a camera, a LiDAR sensor, a radar sensor, and a sonar sensor.

According to an embodiment, the one or more processors predict the drivable path by inputting at least the signal associated with the drivable area into a simulation model.

According to an embodiment, the supervisory computing device is located at a mission control headquarters remote to the sensor apparatus and the autonomous vehicle and operated by a user.

According to an embodiment, the sensor apparatus is used for testing new sensors for the autonomous vehicle

According to an implementation of the present disclosure, a computer-implemented method includes: receiving, by one or more processors of a sensor apparatus, from one or more sensors, an indication of a presence of an autonomous vehicle at a drivable intersection associated with the sensor apparatus; alerting, by the one or more processors, a supervisory computing device of the presence of the autonomous vehicle at the drivable intersection; receiving, by the one or more processors, from the one or more sensors, a signal associated with a drivable area on which the autonomous vehicle may travel; predicting, by the one or more processors, a drivable path for the autonomous vehicle entering the drivable intersection; transmitting, by the one or more processors, to a supervisory module, an indication of the drivable path; requesting, by the one or more processors, from the supervisory computing device, an approval for the autonomous vehicle to adjust an operating parameter to travel on the drivable path in view of other vehicles at the drivable intersection; receiving, by the one or more processors, from the supervisory computing device, the approval to adjust the operating parameter to travel on the drivable path; and upon receiving the approval, transmitting, by the one or more processors, to an electronic control unit of the autonomous vehicle, a control signal to adjust the operating parameter to initiate travelling on the drivable path.

According to an embodiment, the sensor apparatus is permanently installed proximate the drivable intersection.

According to an embodiment, the one or more sensors include at least one of a camera, a LiDAR sensor, a radar sensor, and a sonar sensor.

According to an embodiment, the one or more processors predict the drivable path by inputting at least the signal associated with the drivable area into a simulation model.

According to an embodiment, the supervisory computing device is located at a mission control headquarters remote to the sensor apparatus and autonomous vehicle and operated by a user.

According to an embodiment, the sensor apparatus is used for testing new sensors for the autonomous vehicle.

According to an implementation of the current disclosure, a method of determining a location of an autonomous vehicle hub includes: receiving, by one or more processors from one or more sensors associated with a portable sensor apparatus, a signal associated with a drivable area; applying, by the one or more processors, the signal associated with the drivable area to a viability model, wherein the viability model is configured to: simulate an entrance procedure of one or more autonomous vehicles into the drivable area; determine, based at least on the signal associated with the drivable area, a drivable surface on which an autonomous vehicle may travel to enter the drivable area; determine, based at least on the signal associated with the drivable area, a frequency in which the drivable surface is available for the autonomous vehicle to enter the drivable area; and output a viability score associated with the drivable area, the viability score indicating a viability of establishing the autonomous vehicle hub proximate the drivable area.

According to an embodiment, the portable sensor apparatus includes one or more sensors used on an autonomous vehicle.

According to an embodiment, the portable sensor apparatus is installed proximate the drivable intersection.

According to an embodiment, the one or more sensors include at least one of a camera, a LiDAR sensor, a radar sensor, and a sonar sensor.

According to an embodiment, the one or more processors determine the drivable surface by inputting at least the signal associated with the drivable area into a simulation model.

According to an embodiment, the viability score is transmitted to a supervisory computing device located at a mission control headquarters remote to the sensor apparatus.

According to an embodiment, the sensor apparatus is used for testing new sensors for an autonomous vehicle.

According to an implementation of the present disclosure, a portable sensor apparatus positioned at a drivable intersection includes: one or more sensors; and one or more processors configured to perform a method of determining a location of an autonomous vehicle hub including: receiving, from one or more sensors associated with the portable sensor apparatus, a signal associated with a drivable area; applying, by the one or more processors, the signal associated with the drivable area to a viability model, wherein the viability model is configured to: simulate an entrance procedure of one or more autonomous vehicles into the drivable area; determine, based at least on the signal associated with the drivable area, a drivable surface on which an autonomous vehicle may travel to enter the drivable area; determine, based at least on the signal associated with the drivable area, a frequency in which the drivable surface is available for the autonomous vehicle to enter the drivable area; an output a viability score associated with the drivable area, the viability score indicating a viability of establishing the autonomous vehicle hub proximate the drivable area.

According to an embodiment, the portable sensor apparatus includes one or more sensors used on an autonomous vehicle.

According to an embodiment, the portable sensor apparatus is installed proximate the drivable intersection.

According to an embodiment, the one or more sensors include at least one of a camera, a LiDAR sensor, a radar sensor, and a sonar sensor.

According to an embodiment, the one or more processors determine the drivable surface by inputting at least the signal associated with the drivable area into a simulation model.

According to an embodiment, the viability score is transmitted to a supervisory computing device located at a mission control headquarters remote to the sensor apparatus.

According to an embodiment, the sensor apparatus is used for testing new sensors for an autonomous vehicle

According to an implementation of the present disclosure, a system includes: a mission control; and a portable sensor apparatus positioned at a drivable intersection and including: one or more sensors; and one or more processors configured to perform a method of determining a location of an autonomous vehicle hub including: receiving, from one or more sensors associated with the portable sensor apparatus, a signal associated with a drivable area; applying, by the one or more processors, the signal associated with the drivable area to a viability model, wherein the viability model is configured to: simulate an entrance procedure of one or more autonomous vehicles into the drivable area; determine, based at least on the signal associated with the drivable area, a drivable surface on which an autonomous vehicle may travel to enter the drivable area; determine, based at least on the signal associated with the drivable area, a frequency in which the drivable surface is available for the autonomous vehicle to enter the drivable area; and output a viability score associated with the drivable area, the viability score indicating a viability of establishing the autonomous vehicle hub proximate the drivable area.

According to an embodiment, the portable sensor apparatus includes one or more sensors used on an autonomous vehicle.

According to an embodiment, the portable sensor apparatus is installed proximate the drivable intersection.

According to an embodiment, the one or more sensors include at least one of a camera, a LiDAR sensor, a radar sensor, and a sonar sensor.

According to an embodiment, the one or more processors determine the drivable surface by inputting at least the signal associated with the drivable area into a simulation model.

According to an embodiment, the viability score is transmitted to a supervisory computing device located at a mission control headquarters remote to the sensor apparatus.

### BRIEF DESCRIPTION OF THE DRAWINGS

The accompanying drawings, which are incorporated in and constitute a part of this specification, illustrate various exemplary embodiments and, together with the description, serve to explain the principles of the disclosed embodiments.

FIG. 1 is a bird's-eye view of a roadway including a schematic representation of a vehicle and aspects of an autonomy system of the vehicle, according to an embodiment.

FIG. 2 is a schematic of the autonomy system of the vehicle, according to an embodiment.

FIG. 3 is a schematic diagram of an intersection analysis system, according to an embodiment.

FIG. 4A is a side view of a permanent sensor apparatus of the intersection analysis system of FIG. 3, according to an embodiment.

FIG. 4B is a side view of a portable sensor apparatus of the intersection analysis system of FIG. 3, according to an embodiment.

FIG. 5A is a bird's-eye view of the intersection analysis system of FIG. 3 implemented, according to an embodiment.

FIG. 5B is a bird's-eye view of the intersection analysis system of FIG. 3 implemented, according to an embodiment.

FIG. 6 is a flow diagram of a process for using the intersection analysis system of FIG. 3, according to an embodiment.

FIG. 7 is a flow diagram of a process for using the intersection analysis system of FIG. 3, according to an embodiment.

### DETAILED DESCRIPTION

The following detailed description describes various features and functions of the disclosed systems and methods with reference to the accompanying figures. In the figures, similar components are identified using similar symbols, unless otherwise contextually dictated. The exemplary system(s) and method(s) described herein are not limiting, and it may be readily understood that certain aspects of the disclosed systems and methods can be variously arranged and combined, all of which arrangements and combinations are contemplated by this disclosure.

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

The disclosure presented herein includes various embodiments and implementations. It should be understood that these embodiments and implementations are presented in an order and structure for exemplary purposes only, and elements from the various embodiments and implementations may be added or removed from the presented embodiments. Additionally, elements found in one embodiment or implementation may substituted or combined with several elements of any other embodiment disclosed herein.

The detailed description describes an exemplary autonomous vehicle that may be used in an intersection analysis system, the intersection analysis system itself, a sensor rig that may be used in the intersection analysis system, an implementation of the intersection analysis system at an existing intersection, an implementation of the intersection analysis system for use in conducting simulations, and methods of executing the intersection analysis system. The headings used herein have been included to aid the reader in navigating the disclosure and should not be construed as limiting in any way. Elements from various sections (as delineated by the headings) may be rearranged and combined to disclose additional embodiments contemplated by the current disclosure.

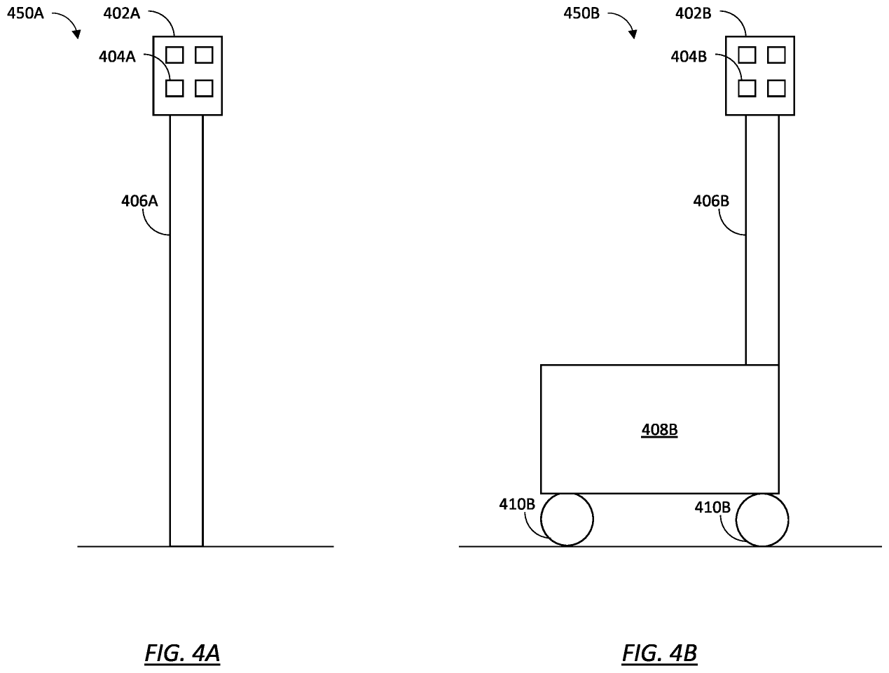

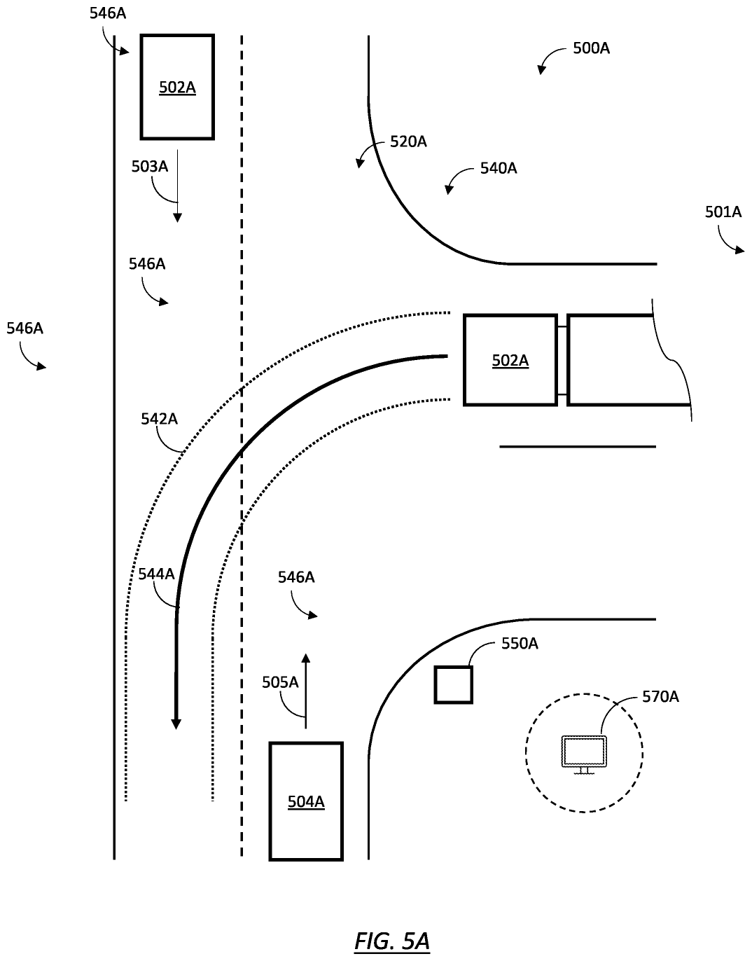

Autonomous vehicle virtual driver systems are structured on three pillars of technology: 1) perception, 2) maps/localization, and 3) behaviors planning and control. The mission of perception is to sense an environment surrounding an ego vehicle and interpret it. To interpret the surrounding environment, a perception engine may identify and classify objects or groups of objects in the environment. For example, an autonomous system may use a perception engine to identify one or more objects (e.g., pedestrians, vehicles, debris, etc.) in the road before a vehicle and classify the objects in the road as distinct from the road. In other examples, the autonomous system may use the perception engine to identify one of more objects (e.g., pedestrians, vehicles, debris, etc.) on the shoulder of the road and classify the object on the shoulder of the road as distinct from the shoulder. At times, the autonomous system must identify objects to the side of the vehicle (e.g., during a left-/right-hand turn into an intersection). These turns prove difficult for autonomous vehicles because of the relative infrequency that ego vehicles, such as tractor trailers, must make these turns. The mission of maps/localization is to determine where in the world, or where on a pre-built map, the ego vehicle is located. One way to do this is to sense the environment surrounding the ego vehicle (e.g., perception systems) and to correlate features of the sensed environment with details (e.g., digital representations of the features of the sensed environment) on a digital map. Once the systems on the ego vehicle have determined its location with respect to the map features (e.g., intersections, road signs, etc.) the ego vehicle (“ego”) can plan maneuvers and/or routes with respect to the features of the environment. The mission of behaviors, planning, and control is to make decisions about how the ego should move through the environment to get to its goal or destination. It consumes information from the perception engine and the maps/localization modules to know where it is relative to the surrounding environment and what other traffic actors are doing. In some instances, as described herein, the ego may receive information regarding the surrounding environment and other traffic actors from a remote device, such as a sensor rig as described in FIGS. 4A-4B.

Localization, or the estimate of ego vehicle's position to varying degrees of accuracy, often with respect to one or more landmarks on a map, is critical information that may enable advanced driver-assistance systems or self-driving cars to execute autonomous driving maneuvers. Such maneuvers can often be mission or safety related. For example, localization may be a prerequisite for an ADAS or a self-driving car to provide intelligent and autonomous driving maneuvers to arrive at point C from points B and A. Currently existing solutions for localization may rely on a combination of Global Navigation Satellite System (GNSS), an inertial measurement unit (IMU), and a digital map (e.g., an HD map or other map file including one or more semantic layers).

Localizations can be expressed in various forms based on the medium in which they may be expressed. For example, a vehicle could be globally localized using a global positioning reference frame, such as latitude and longitude. The relative location of the ego vehicle with respect to one or more objects or features in the surrounding environment could then be determined with knowledge of ego vehicle's global location and the knowledge of the one or more objects' or feature's global location(s). Alternatively, an ego vehicle could be localized with respect to one or more features directly. To do so, the ego vehicle may identify and classify one or more objects or features in the environment and may do this using, for example, its own onboard sensing systems (e.g., perception systems), such as LiDARs, cameras, radars, etc. and one or more on-board computers storing instructions for such identification and classification.

Environments intended for use by vehicles, whether such vehicles include autonomous features or not, tend to be pattern rich. That is, environments intended for use by automobiles are structured according to a pattern(s) that is recognizable by human drivers and increasingly by autonomous systems (e.g., all stop signs use same shape/color, all stop lights are green/yellow/red, etc.) The patterns enable and, indeed, may require predictable behavior by the operators of the vehicles in the environment, whether human or machine. One such pattern is used in lane indications, which may indicate lane boundaries intended to require particular behavior within the lane (e.g., maintaining a constant path with respect to the lane line, not crossing a solid lane line, etc.). Due to their consistency, predictability, and ubiquity, lane lines may serve as a good basis for a lateral component localization.

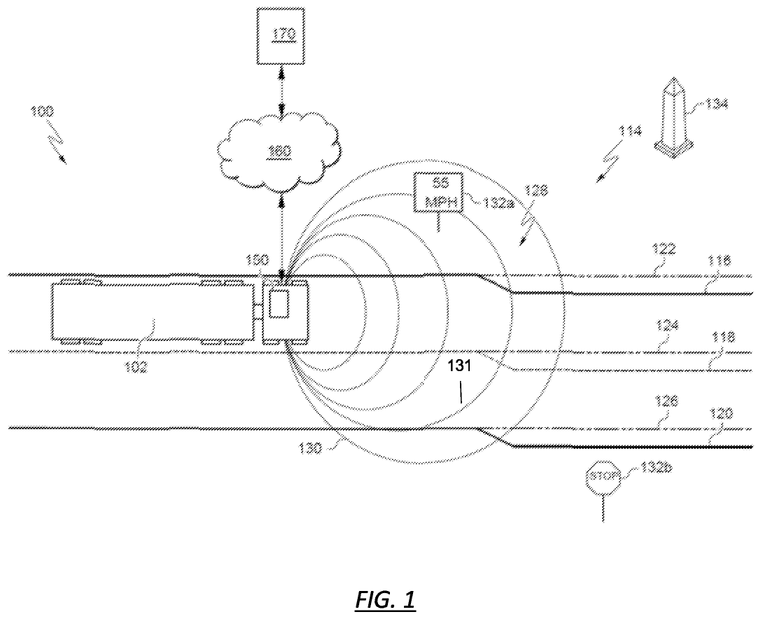

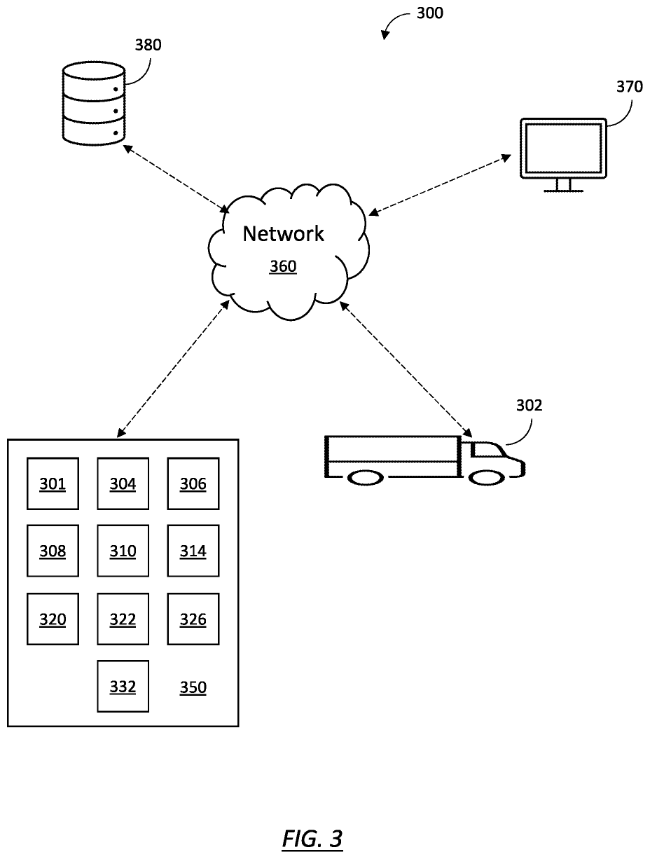

Referring to FIG. 1, on aspect of the present disclosure relates to autonomous vehicles, such as an autonomous truck 102 having an autonomy system 150. The autonomy system 150 of truck 102 may be completely autonomous (fully-autonomous), such as self-driving, driverless, or Level 4 autonomy, or semi-autonomous, such as Level 3 autonomy. As used herein the term “autonomous” includes both fully-autonomous and semi-autonomous. In some embodiments of the current disclosure, the truck 102 may also have human-operated backup systems to ensure safety in certain, predictable situations encountered by the truck 102. For example, entering an intersection is a known situation that poses cost and safety concerns for truck 102. Because this situation poses specific and known safety concerns, the truck 102 may be provided with additional (e.g., human) approval prior to entering the intersection. Various embodiments of implementing this additional approval are disclosed herein in greater detail in FIGS. 3-6.

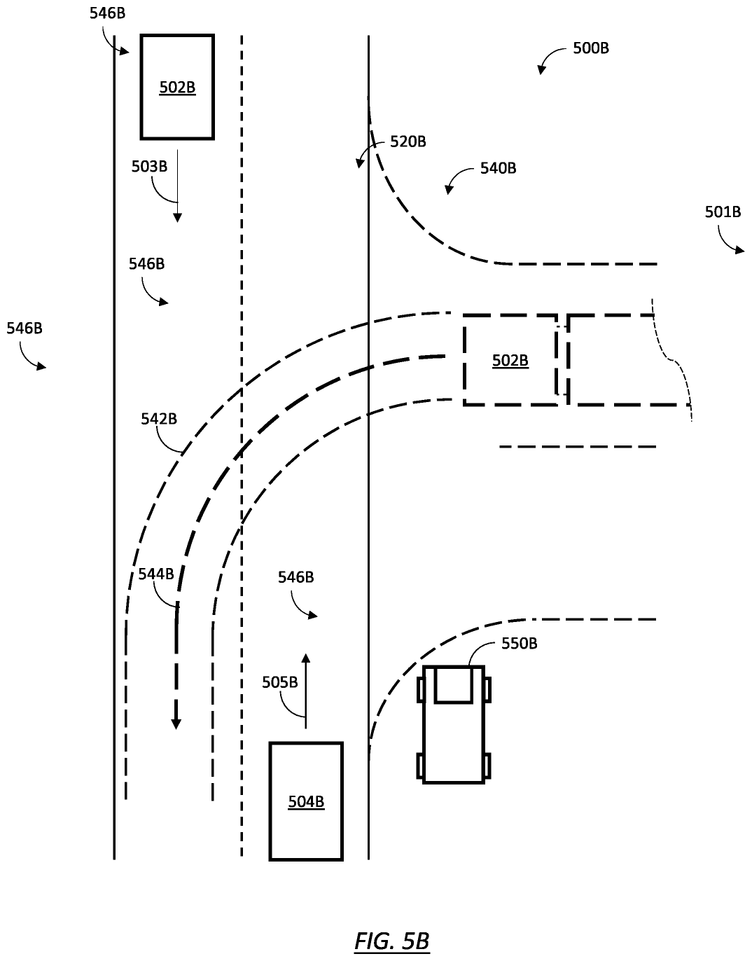

The present disclosure sometimes refers to autonomous vehicles as ego vehicles. The autonomy system 150 (which may include elements remote to truck 102) may be structured on at least three aspects of technology: (1) perception, (2) maps/localization, and (3) behaviors planning and control. The function of the perception aspect is to sense an environment surrounding truck 102 and interpret it. To interpret the surrounding environment, a perception module or engine in the autonomy system 150 of the truck 102 may identify and classify objects or groups of objects in the environment. For example, a perception module associated with various sensors (e.g., LiDAR, camera, radar, etc.) of the autonomy system 150 may identify one or more objects (e.g., pedestrians, vehicles, debris, etc.) and features of the roadway (e.g., lane lines, objects on the shoulder) around truck 102, and classify the objects in and around the road distinctly. As described in FIGS. 3-7, all or some of the perception model (including LiDAR, camera, radar, sonar, etc.) may be implemented remote to truck 102 (e.g., as described in FIG. 5A).

The maps/localization aspect of the autonomy system 150 may be configured to determine where on a pre-established digital map the truck 102 is currently located. One way to do this is to sense the environment surrounding the truck 102 (e.g., via the perception system) and to correlate features of the sensed environment with details (e.g., digital representations of the features of the sensed environment) on the digital map.

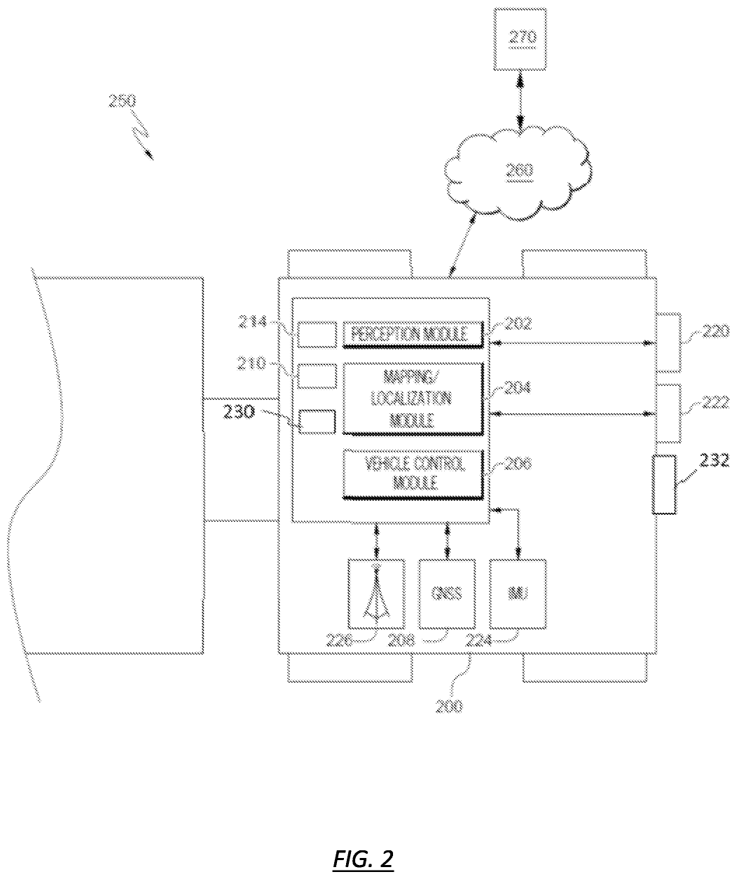

Once the systems on the truck 102 have determined its location with respect to the digital map features (e.g., location on the roadway, upcoming intersections, road signs, etc.), the truck 102 can plan and execute maneuvers and/or routes with respect to the features of the digital map. The behaviors, planning, and control aspects of the autonomy system 150 may be configured to make decisions about how the truck 102 should move through the environment to get to its goal or destination. It may consume information from the perception and maps/localization modules to know where it is relative to the surrounding environment and what other objects and traffic actors are doing. Again, all or portions of the localization model may be implemented remote to truck 102 and communicated to truck 102 through a transceiver 226 of FIG. 2.

FIG. 1 further illustrates a system 100 for modifying one or more actions of truck 102 using the autonomy system 150. The truck 102 is capable of communicatively coupling to a remote server 170 via a network 160. The truck 102 may not necessarily connect with the network 160 or server 170 while it is in operation (e.g., driving down the roadway). That is, the server 170 may be remote from the vehicle, and the truck 102 may deploy with all the necessary perception, localization, and vehicle control software and data necessary to complete its mission fully-autonomously or semi-autonomously. However, in some embodiments, the truck 102 may communicate with the network 160 or server 170 during operation to implement the autonomy system 150. For example, truck 102 may communicate with a mission control 370 or sensor rig 250 of FIG. 3 to receive approval for certain maneuvers (e.g., entering an intersection).

While this disclosure refers to a truck (e.g., a tractor trailer) 102 as the autonomous vehicle, it is understood that the truck 102 could be any type of vehicle including an automobile, a mobile industrial machine, etc. While the disclosure will discuss a self-driving or driverless, fully contained autonomous system, it is understood that certain embodiments disclosed herein include an autonomous system (or semi-autonomous system) that receives perception data, localization data, and route planning decisions from components of the autonomous system 250 remote to truck 102. These components may include the network 160, the server 170, the sensor rig 550A of FIG. 5A.

With reference to FIG. 2, an autonomy system 250 may include a perception system including a camera system 220, a LiDAR system 222, a radar system 232, a GNSS receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. In other examples, the autonomy system 250 may include more, fewer, or different components or systems, and each of the components or system(s) may include more, fewer, or different components. Additionally, the systems and components shown may be combined or divided in various ways. As show in FIG. 1, the perception systems aboard the autonomous vehicle may help the truck 102 perceive its environment out to a perception radius 130. The actions of the truck 102 may depend on the extent of perception radius 130. In some embodiments, the truck 102 may be able to perceive to different perception radius with different sensor equipment (e.g., camera system 220 and LiDAR system 222). For example, the truck 102 may be able to perceive to perception radius 130 with the camera system 220 but may only be able to perceive to radius 131 with the LiDAR system 222.

The camera system 220 of the perception system may include one or more cameras mounted at any location on the truck 102, which may be configured to capture images of the environment surrounding the truck 102 in any aspect or field of view (FOV). The FOV can have any angle or aspect such that images of the areas ahead of, to the side, and behind the truck 102 may be captured. In some embodiments, the FOV may be limited to particular areas around the truck 102 (e.g., forward of the truck 102) or may surround 360 degrees of the truck 102. In some embodiments, the image data generated by the camera system(s) 220 may be sent to the perception module 202 and stored, for example, in memory 214. In some embodiments, the camera system 220 may be able to capture reliable image data at a distance farther than the LiDAR system 222.

The LiDAR system 222 may include a laser generator and a detector and can send and receive LiDAR signals. The LiDAR signal can be emitted to and received from any direction such that LiDAR point clouds (or “LiDAR images”) of the areas ahead of, to the side, and behind the truck 200 can be captured and stored as LiDAR point clouds. In some embodiments, the truck 200 may include multiple LiDAR systems and point cloud data from the multiple systems may be stitched together. In some embodiments, the system inputs from the camera system 220 and the LiDAR system 222 may be fused (e.g., in the perception module 202). The LiDAR system 222 may include one or more actuators to modify a position and/or orientation of the LiDAR system 222 or components thereof. The LiDAR system 222 may be configured to use ultraviolet (UV), visible, or infrared light to image objects and can be used with a wide range of targets. In some embodiments, the LiDAR system 222 can be used to map physical features of an object with high resolution (e.g., using a narrow laser beam). In some examples, the LiDAR system 222 may generate a point cloud and the point cloud may be rendered to visualize the environment surrounding the truck 200 (or object(s) therein). In some embodiments, the point cloud may be rendered as one or more polygon(s) or mesh model(s) through, for example, surface reconstruction. Collectively, the LiDAR system 222 and the camera system 220 may be referred to herein as “imaging systems.”

The radar system 232 may estimate strength or effective mass of an object, as objects made out of paper or plastic may be weakly detected. The radar system 232 may be based on 24 GHZ, 77 GHz, or other frequency radio waves. The radar system 232 may include short-range radar (SRR), mid-range radar (MRR), or long-range radar (LRR). One or more sensors may emit radio waves, and a processor process received reflected data (e.g., raw radar sensor data).

The GNSS receiver 208 may be positioned on the truck 200 and may be configured to determine a location of the truck 200 via GNSS data, as described herein. The GNSS receiver 208 may be configured to receive one or more signals from a global navigation satellite system (GNSS) (e.g., GPS system) to localize the truck 200 via geolocation. The GNSS receiver 208 may provide an input to and otherwise communicate with mapping/localization module 204 to, for example, provide location data for use with one or more digital maps, such as an HD map (e.g., in a vector layer, in a raster layer or other semantic map, etc.). In some embodiments, the GNSS receiver 208 may be configured to receive updates from an external network.

The IMU 224 may be an electronic device that measures and reports one or more features regarding the motion of the truck 200. For example, the IMU 224 may measure a velocity, acceleration, angular rate, and or an orientation of the truck 200 or one or more of its individual components using a combination of accelerometers, gyroscopes, and/or magnetometers. The IMU 224 may detect linear acceleration using one or more accelerometers and rotational rate using one or more gyroscopes. In some embodiments, the IMU 224 may be communicatively coupled to the GNSS receiver 208 and/or the mapping/localization module 204, to help determine a real-time location of the truck 200, and predict a location of the truck 200 even when the GNSS receiver 208 cannot receive satellite signals.

The transceiver 226 may be configured to communicate with one or more external networks 260 via, for example, a wired or wireless connection in order to send and receive information (e.g., to a remote server 270). The wireless connection may be a wireless communication signal (e.g., Wi-Fi, cellular, LTE, 5g, etc.) In some embodiments, the transceiver 226 may be configured to communicate with external network(s) via a wired connection, such as, for example, during initial installation, testing, or service of the autonomy system 250 of the truck 200. A wired/wireless connection may be used to download and install various lines of code in the form of digital files (e.g., HD digital maps), executable programs (e.g., navigation programs), and other computer-readable code that may be used by the system 250 to navigate the truck 200 or otherwise operate the truck 200, either fully-autonomously or semi-autonomously. The digital files, executable programs, and other computer readable code may be stored locally or remotely and may be routinely updated (e.g., automatically or manually) via the transceiver 226 or updated on demand. In some embodiments, the truck 200 may not be in constant communication with the network 260 and updates which would otherwise be sent from the network 260 to the truck 200 may be stored at the network 260 until such time as the network connection is restored. In some embodiments, the truck 200 may deploy with all of the data and software it needs to complete a mission (e.g., necessary perception, localization, and mission planning data) and may not utilize any connection to network 260 during some or the entire mission. Additionally, the truck 200 may send updates to the network 260 (e.g., regarding unknown or newly detected features in the environment as detected by perception systems) using the transceiver 226. For example, when the truck 200 detects differences in the perceived environment with the features on a digital map, the truck 200 may update the network 260 with information, as described in greater detail herein.

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. Autonomy system 250 may include a single microprocessor or multiple microprocessors that may include means for identifying and reacting to differences between features in the perceived environment and features of the maps stored on the truck 200. Numerous commercially available microprocessors can be configured to perform the functions of the autonomy system 250. It should be appreciated that autonomy system 250 could include a general machine controller capable of controlling numerous other machine functions. Alternatively, a special-purpose machine controller could be provided. Further, the autonomy system 250, or portions thereof, may be located remote from the system 250. For example, one or more features of the mapping/localization module 204 could be located remote of truck 200. Various other known circuits may be associated with the autonomy system 250, including signal-conditioning circuitry, communication circuitry, actuation circuitry, and other appropriate circuitry.

The memory 214 of autonomy system 250 may store data and/or software routines that may assist the autonomy system 250 in performing its functions, such as the functions of the perception module 202, the mapping/localization module 204, the vehicle control module 206, a collision analysis module 230, the method 500 described herein with respect to FIG. 5. Further, the memory 214 may also store data received from various inputs associated with the autonomy system 250, such as perception data from the perception system.

As noted above, perception module 202 may receive input from the various sensors, such as camera system 220, LiDAR system 222, GNSS receiver 208, and/or IMU 224 (collectively “perception data”) to sense an environment surrounding the truck 200 and interpret it. To interpret the surrounding environment, the perception module 202 (or “perception engine”) may identify and classify objects or groups of objects in the environment. For example, the truck 102 may use the perception module 202 to identify one or more objects (e.g., pedestrians, vehicles, debris, etc.) or features of the roadway 114 (e.g., intersections, road signs, lane lines, etc.) before or beside a vehicle and classify the objects in the road. In some embodiments, the perception module 202 may include an image classification function and/or a computer vision function.

The system 100 may collect perception data. The perception data may represent the perceived environment surrounding the vehicle, for example, and may be collected using aspects of the perception system described herein. The perception data can come from, for example, one or more of the LiDAR system, the camera system, and various other externally-facing sensors and systems on board the vehicle (e.g., the GNSS receiver, etc.). For example, on vehicles having a sonar or radar system, the sonar and/or radar systems may collect perception data. As the truck 102 travels along the roadway 114, the system 100 may continually receive data from the various systems on the truck 102. In some embodiments, the system 100 may receive data periodically and/or continuously. With respect to FIG. 1, the truck 102 may collect perception data that indicates presence of the lane lines 116, 118, 120. Features perceived by the vehicle should generally track with one or more features stored in a digital map (e.g., in the mapping/localization module 204). Indeed, with respect to FIG. 1, the lane lines that are detected before the truck 102 is capable of detecting the bend 128 in the road (that is, the lane lines that are detected and correlated with a known, mapped feature) will generally match with features in stored map and the vehicle will continue to operate in a normal fashion (e.g., driving forward in the left lane of the roadway or per other local road rules). However, in the depicted scenario the vehicle approaches a new bend 128 in the road that is not stored in any of the digital maps onboard the truck 102 because the lane lines 116, 118, 120 have shifted right from their original positions 122, 124, 126. This lane-line sensing capabilities may be beneficial in determining the location of the shoulder of the road and any corresponding objects thereon.

The system 100 may compare the collected perception data with stored data. For example, the system may identify and classify various features detected in the collected perception data from the environment with the features stored in a digital map. For example, the detection systems may detect the lane lines 116, 118, 120 and may compare the detected lane lines with lane lines stored in a digital map. Additionally, the detection systems could detect the road signs 132a, 132b and the landmark 134 to compare such features with features in a digital map. The features may be stored as points (e.g., signs, small landmarks, etc.), lines (e.g., lane lines, road edges, etc.), or polygons (e.g., lakes, large landmarks, etc.) and may have various properties (e.g., style, visible range, refresh rate, etc.), which properties may control how the system 100 interacts with the various features. Based on the comparison of the detected features with the features stored in the digital map(s), the system may generate a confidence level, which may represent a confidence of the vehicle in its location with respect to the features on a digital map and hence, its actual location.

The image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image. The image classification function may be embodied by a software module that may be communicatively coupled to a repository of images or image data (e.g., visual data and/or point cloud data) which may be used to determine objects and/or features in real time image data captured by, for example, the camera system 220 and the LiDAR system 222. In some embodiments, the image classification function may be configured to classify features based on information received from only a portion of the multiple available sources. For example, in the case that the captured visual camera data includes images that may be blurred, the system 250 may identify objects based on data from one or more of the other systems (e.g., LiDAR system 222) that does not include the image data.

At various distances, the image classification function may be able to detect and classify certain objects with varying degrees of fidelity. For example, during the operation of truck 102, the image classification system may use data collected from the camera system 220 to detect the presence of an object at a maximum perception distance (e.g., perception radius 130). This may be a binary classification at the maximum perception distance: either an object is present or not. As the truck 102 proceeds towards the object, the camera system 220 may collect higher resolution data from which the image classification function may make higher fidelity classifications. For example, the image classification system may be able to extend its classification from simply the presence of an object to what the object is (e.g., a vehicle, an animal, a pedestrian). The image classification function may utilize data from the LiDAR system 222 as well. In some examples, the data collected from the LiDAR system 222 may provide the image classification system with even higher fidelity classification capabilities than the camera system 220. The LiDAR system 222 may be able to collect object-classification data during night, during a snowstorm, and in other conditions that otherwise present a traditional camera system with difficulties during perception.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the truck 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of its motion, size, etc.)

Mapping/localization module 204 receives perception data that can be compared to one or more digital maps stored in the mapping/localization module 204 to determine where the truck 200 is in the world and/or or where the truck 200 is on the digital map(s). In particular, the mapping/localization module 204 may receive perception data from the perception module 202 and/or from the various sensors sensing the environment surrounding the truck 200 and may correlate features of the sensed environment with details (e.g., digital representations of the features of the sensed environment) on the one or more digital maps. The digital map may have various levels of detail and can be, for example, a raster map, a vector map, etc. The digital maps may be stored locally on the truck 200 and/or stored and accessed remotely. In at least one embodiment, the truck 200 deploys with sufficiently stored information in one or more digital map files to complete a mission without connection to an external network during the mission. A centralized mapping system may be accessible via network 260 for updating the digital map(s) of the mapping/localization module 204. The digital map be built through repeated observations of the operating environment using the truck 200 and/or trucks or other vehicles with similar functionality. For instance, the truck 200, a specialized mapping vehicle, a standard autonomous vehicle, or another vehicle, can run a route several times and collect the location of all targeted map features relative to the position of the vehicle conducting the map generation and correlation. These repeated observations can be averaged together in a known way to produce a highly accurate, high-fidelity digital map. This generated digital map can be provided to each vehicle (e.g., from the network 260 to the truck 200) before the vehicle departs on its mission so it can carry it onboard and use it within its mapping/localization module 204. Hence, the truck 200 and other vehicles (e.g., a fleet of trucks similar to the truck 200) can generate, maintain (e.g., update), and use their own generated maps when conducting a mission.

The generated digital map may include an assigned confidence score assigned to all or some of the individual digital feature representing a feature in the real world. The confidence score may be meant to express the level of confidence that the position of the element reflects the real-time position of that element in the current physical environment. Upon map creation, after appropriate verification of the map (e.g., running a similar route multiple times such that a given feature is detected, classified, and localized multiple times), the confidence score of each element will be very high, possibly the highest possible score within permissible bounds.

The vehicle control module 206 may control the behavior and maneuvers of the truck 200. For example, once the systems on the truck 200 have determined its location with respect to map features (e.g., intersections, road signs, lane lines, etc.) the truck 200 may use the vehicle control module 206 and its associated systems to plan and execute maneuvers and/or routes with respect to the features of the environment. The vehicle control module 206 may make decisions about how the truck 200 will move through the environment to get to its goal or destination as it completes its mission. The vehicle control module 206 may consume information from the perception module 202 and the maps/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the truck 200 and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the truck 200. The steering system may be any combination of mechanisms configured to adjust the heading or direction of the truck 200. The brake system may be, for example, any combination of mechanisms configured to decelerate the truck 200 (e.g., friction braking system, regenerative braking system, etc.) The vehicle control module 206 may be configured to avoid obstacles in the environment surrounding the truck 200 (such as on the shoulder of the road) and may be configured to use one or more system inputs to identify, evaluate, and modify a vehicle trajectory. The vehicle control module 206 is depicted as a single module but can be any combination of software agents and/or hardware modules able to generate vehicle control signals operative to monitor systems and control various vehicle actuators. The vehicle control module 206 may include a steering controller and for vehicle lateral motion control and a propulsion and braking controller for vehicle longitudinal motion.

### Description of Intersection Analysis System

With reference to FIG. 3, an intersection analysis system 300 may include a truck 302 (e.g., truck 102 of FIG. 1), a sensor rig 350, a network 360, a mission control 370, and a database 380. The truck 302 may be substantially similar to the truck 102 of FIG. 1 and may have varying degrees of autonomy from fully autonomous to semi-autonomous.

The sensor rig 350 may be a remote apparatus positioned (either permanently or temporarily) at a location where additional sensing may be required to ensure safety. For example, the sensor rig 350 may be placed at an exit of an autonomous vehicle hub at an intersection with a road or other thoroughfare. Entering intersections (especially in a left-hand turn maneuver) can be a dangerous process for autonomous vehicles (e.g., truck 302). Special sensing equipment may be placed on the truck 302 to aid in accomplishing such maneuvers safely. This special sensing equipment, configured to perceive and interpret data corresponding to an environment surrounding the truck 302 (e.g., 90 degrees to the direction of travel of the truck 302), can increase costs and, in some instances, are only used for infrequent maneuvers (e.g., entering an intersection). To avoid including this costly equipment on each vehicle in a fleet of autonomous vehicles, the sensing equipment needed to ensure safe entrance into an intersection may be permanently or temporarily placed at an intersection of interest on the sensor rig 350 that is configured to perceive the environment surrounding, including the intersection of interest, and communicate the relevant information associated with the perceived data to the truck 302, the mission control 370, and the database 380 to aid the truck 302 safely maneuver the intersection.

Just as with the autonomy system of FIG. 2, the sensor rig 350 may include a perception system including a camera system 320, a LiDAR system 322, a radar system 332, a GNSS receiver 308, an inertial measurement unit (IMU), and/or a perception module 301. The sensor rig 350 may further include a transceiver 326, a processor 310, a memory 314, a mapping/localization module 304, and a vehicle control module 306. The various systems may serve as inputs to and receive outputs from various other components of the intersection analysis system 300 (e.g., the simulations and models described herein). In other examples, the intersection analysis system 300 and/or the sensor rig 350 may include more, fewer, or different components or systems, and each of the components or system(s) may include more, fewer, or different components. Additionally, the systems and components shown may be combined or divided in various ways. As show in FIG. 1, the perception systems implemented on the intersection analysis system 300 may help the sensor rig 350 and truck 302 perceive its environment out to a certain perception radius. The actions of the truck 302 may depend on the extent of the perception radius of the sensor rig 350. In some embodiments, the sensor rig 350 may be able to perceive to different perception radius with different sensor equipment (e.g., camera system 320 and LiDAR system 322). For example, the sensor rig 350 may be able to perceive to a perception radius with the camera system 320, but may be able to perceive to a smaller radius with the LiDAR system 322.

The camera system 320 of the perception system may include one or more cameras mounted at any location on the sensor rig 350, which may be configured to capture images of the environment surrounding the sensor rig 350 in any aspect or field of view (FOV). The FOV can have any angle or aspect such that images of the areas ahead of, to the side, and behind the sensor rig 350 may be captured. In some embodiments, the FOV may be limited to particular areas around the sensor rig 350 (e.g., forward of the sensor rig 350) or may surround 360 degrees of the sensor rig 350. In some embodiments, the image data generated by the camera system(s) 320 may be sent to the perception module 301 and stored, for example, in memory 314. In other embodiments, the image data generated by the camera system(s) 320 may be sent to the database 380 or the mission control 370 and stored. In some embodiments, the camera system 320 may be able to capture reliable image data at a distance farther than the LiDAR system 322.

The LiDAR system 322 may include a laser generator and a detector and can send and receive LiDAR signals. The LiDAR signal can be emitted to and received from any direction such that LiDAR point clouds (or “LiDAR images”) of the areas ahead of, to the side, and behind the sensor rig 350 can be captured and stored as LiDAR point clouds. In some embodiments, the sensor rig 350 may include multiple LiDAR systems and point cloud data from the multiple systems may be stitched together. In some embodiments, the system inputs from the camera system 320 and the LiDAR system 322 may be fused (e.g., in the perception module 301). The LiDAR system 322 may include one or more actuators to modify a position and/or orientation of the LiDAR system 322 or components thereof. The LiDAR system 322 may be configured to use ultraviolet (UV), visible, or infrared light to image objects and can be used with a wide range of targets. In some embodiments, the LiDAR system 322 can be used to map physical features of an object with high resolution (e.g., using a narrow laser beam). In some examples, the LiDAR system 322 may generate a point cloud and the point cloud may be rendered to visualize the environment surrounding the sensor rig 350 (or object(s) therein). In some embodiments, the point cloud may be rendered as one or more polygon(s) or mesh model(s) through, for example, surface reconstruction. Collectively, the LiDAR system 322 and the camera system 320 may be referred to herein as “imaging systems.”

The radar system 332 may estimate strength or effective mass of an object, as objects made out of paper or plastic may be weakly detected. The radar system 332 may be based on 24 GHZ, 77 GHz, or other frequency radio waves. The radar system 332 may include short-range radar (SRR), mid-range radar (MRR), or long-range radar (LRR). One or more sensors may emit radio waves, and a processor process received reflected data (e.g., raw radar sensor data).

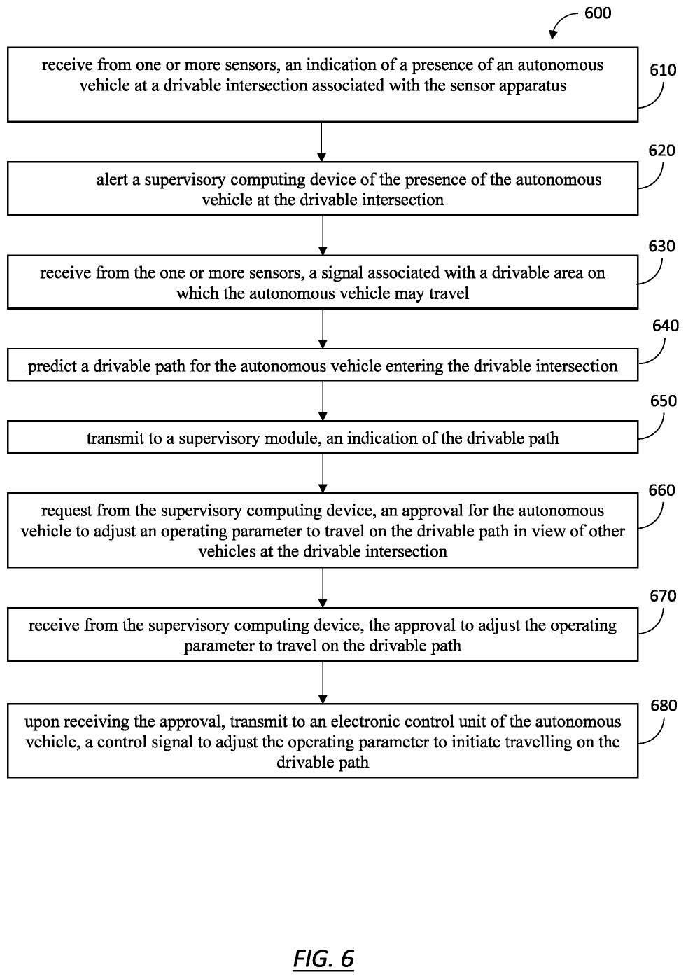

The GNSS receiver 308 may be positioned on the sensor rig 350 and may be configured to determine a location of the sensor rig 350 via GNSS data, as described herein. The GNSS receiver 308 may be configured to receive one or more signals from a global navigation satellite system (“GNSS”) (e.g., GPS system) to localize the sensor rig 350 via geolocation. The GNSS receiver 308 may provide an input to and otherwise communicate with mapping/localization module 304 to, for example, provide location data for use with one or more digital maps, such as an HD map (e.g., in a vector layer, in a raster layer or other semantic map, etc.). In some embodiments, the GNSS receiver 308 may be configured to receive updates from an external network. The GNSS receiver 308 may be particularly useful for portable/transportable embodiments of the sensor rig 350. For example, a portable sensor rig 350 (e.g., portable sensor rig 450B of FIG. 4B) may be positioned at any intersection or location and the GNSS receiver 308 may triangulate its position using GNSS data received and then transmit this triangulated position to the database 380, the mission control 370, and/or the truck 302. The database 380, the mission control 370, and/or the truck 302 may then use the triangulated data to input into models and/or simulations (e.g., the simulation described in FIG. 6B) to improve accuracy, reliability, and speed, of the simulations. In addition, additional perceived data from the perception model 302 (e.g., number of objects, license plates, time of day, etc.) may be correlated/associated with the GNSS data.

The transceiver 326 may be configured to communicate with one or more external networks 360 via, for example, a wired or wireless connection in order to send and receive information (e.g., to the mission control 370). The wireless connection may be a wireless communication signal (e.g., Wi-Fi, cellular, LTE, 5g, etc.) In some embodiments, the transceiver 326 may be configured to communicate with external network(s) via a wired connection, such as, for example, during initial installation, testing, or service of the intersection analysis system 300. A wired/wireless connection may be used to download and install various lines of code in the form of digital files (e.g., HD digital maps), executable programs (e.g., navigation programs), and other computer-readable code that may be used by the intersection analysis system 300 to navigate the truck 302 or otherwise operate the truck 302 either fully-autonomously or semi-autonomously, through communicating the with truck transceiver 226. The digital files, executable programs, and other computer readable code may be stored locally or remotely and may be routinely updated (e.g., automatically or manually) via the transceiver 326 or updated on demand. In some embodiments, the sensor rig 350 may not be in constant communication with the network 360 and updates which would otherwise be sent from the network 360 to the sensor rig 350 may be stored at the network 360 until such time as the network connection is restored. In some embodiments, the sensor rig 350 may deploy with all of the data and software it needs to complete an intersection event (e.g., necessary perception, localization, and mission planning data) and may not utilize any connection to network 360 during some or the entire mission. Additionally, the sensor rig 350 may send updates to the network 360 (e.g., regarding unknown or newly detected features in the environment as detected by perception systems) using the transceiver 326. For example, when the sensor rig 350 detects changes in the perceived environment, the sensor rig 350 may update the network 360 or database 380 with information, as described in greater detail herein.

The processor 310 of sensor rig 350 may be embodied as one or more of a data processor, a microcontroller, a microprocessor, a digital signal processor, a logic circuit, a programmable logic array, or one or more other devices for controlling the sensor rig 350 in response to one or more of the system inputs. The sensor rig 350 may include a single microprocessor or multiple microprocessors that may include means for identifying and reacting to differences between features in the perceived surrounding the sensor rig 350. Numerous commercially available microprocessors can be configured to perform the functions of the sensor rig 350. It should be appreciated that the sensor rig 350 could include a general machine controller capable of controlling numerous other machine functions. Alternatively, a special-purpose machine controller could be provided. Further, the sensor rig 350, or portions thereof, may be located remote from the intersection analysis system 300. For example, one or more features of the mapping/localization module 304 could be located remote of the sensor rig 350. Various other known circuits may be associated with the intersection analysis system 300/sensor rig 350, including signal-conditioning circuitry, communication circuitry, actuation circuitry, and other appropriate circuitry.

The memory 314 of intersection analysis system 300 may store data and/or software routines that may assist the intersection analysis system 300 in performing its functions, such as the functions of the perception module 301, the mapping/localization module 304, the vehicle control module 306, a collision analysis module, the method 600, and the method 700 described herein. Further, the memory 314 may also store data received from various inputs associated with the intersection analysis system 300, such as perception data from the perception module 301.

As noted above, perception module 301 may receive input from the various sensors, such as camera system 320, LiDAR system 322, GNSS receiver 308, and/or IMU (collectively “perception data”) to sense an environment surrounding the sensor rig 350 and interpret it. To interpret the surrounding environment, the perception module 301 (or “perception engine”) may identify and classify objects or groups of objects in the environment. For example, the sensor rig 350 may use the perception module 301 to identify one or more objects (e.g., pedestrians, vehicles, debris, etc.) or features of the intersection 540A of FIG. 5A (e.g., surface condition, road signs, lane lines, etc.) before or beside a vehicle and classify the objects in the road. In some embodiments, the perception module 301 may include an image classification function and/or a computer vision function.

The sensor rig 350 may collect perception data. The perception data may represent the perceived environment surrounding the vehicle, for example, and may be collected using aspects of the perception system described herein. The perception data can come from, for example, one or more of the LiDAR system 322, the camera system 320, and various other externally-facing sensors of the sensor rig 350 (e.g., the GNSS receiver 308, etc.). For example, on vehicles having a sonar or radar system, the sonar and/or radar systems may collect perception data. The sensor rig 350 may continually receive data from the various systems on the sensor rig 350. In some embodiments, the sensor rig 350 may receive data periodically and/or continuously. With respect to FIG. 5A, the sensor rig 350 may collect perception data that indicates presence of the lane lines associated with a road 520A and vehicles 502A, 502B.

The image classification function may determine the features of an image (e.g., a visual image from the camera system 320 and/or a point cloud from the LiDAR system 322). The image classification function can be any combination of software agents and/or hardware modules able to identify image features and determine attributes of image parameters in order to classify portions, features, or attributes of an image. The image classification function may be embodied by a software module that may be communicatively coupled to a repository of images or image data (e.g., visual data and/or point cloud data) which may be used to determine objects and/or features in real time image data captured by, for example, the camera system 320 and the LiDAR system 322. In some embodiments, the image classification function may be configured to classify features based on information received from only a portion of the multiple available sources. For example, in the case that the captured visual camera data includes images that may be blurred, the system 350 may identify objects based on data from one or more of the other systems (e.g., LiDAR system 322) that does not include the image data.

The computer vision function may be configured to process and analyze images captured by the camera system 320 and/or the LiDAR system 322 or stored on one or more modules of the intersection analysis system 300 (e.g., in the memory 314), to identify objects and/or features in the environment surrounding the sensor rig 350. The computer vision function may use, for example, an object recognition algorithm, video tracing, one or more photogrammetric range imaging techniques (e.g., a structure from motion (“SfM”) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of its motion, size, etc.)

Mapping/localization module 304 receives perception data that can be compared to one or more digital maps stored in the mapping/localization module 304 to determine where the sensor rig 350 is in the world and/or or where the sensor rig 350 is on the digital map(s). In particular, the mapping/localization module 304 may receive perception data from the perception module 301 and/or from the various sensors sensing the environment surrounding the sensor rig 350 and may correlate features of the sensed environment with details (e.g., digital representations of the features of the sensed environment) on the one or more digital maps. The digital map may have various levels of detail and can be, for example, a raster map, a vector map, etc. The digital maps may be stored locally on the sensor rig 350 and/or stored and accessed remotely (e.g., through the network 360).

The mission control 370 of the intersection analysis system 300 may be a remote, control center in communication with the database 380, the sensor rig 350, the truck 302, and/or the network 360. The mission control may be one or more computing devices utilizing one or more processors to interpret the data perceived and transmitted by the sensor rig 350. In some embodiments, human supervisors operate the one or more computing devices of the mission control 370. In an exemplary implementation of intersection analysis system 300 incorporating the mission control 370 is further described in FIGS. 5A-7. The computing devices of the mission control 370 may be in communication to receive from, and transmit to, the sensor rig 350 and the truck 302. The mission control 370 may be remote to the sensor rig 350 and/or the truck 302, and in communication thereto with wireless communication protocols. In some embodiments, the mission control 370 is stored locally on the sensor rig 350 and/or the truck 302.

The database 380 may also communicatively couple to the network 360. The database 360 may acquire real-time data transmitted by various data sources, such as the mission control 370, the truck 302, and/or the sensor rig 350. The database 380 may be a relational database management system that stores and retrieves data as requested by various software applications and or components of the intersection analysis system 300. By way of example, the database 380 may be a SQL server, an ORACLE server, an SAP server, or the like.

The database 380 may also store various models and simulation protocols (e.g., an intersection entrance simulation, an autonomous vehicle hub viability model, ab intersection exit simulation, a traffic light placement simulation, etc.) that may be executed by the various components and/or processors of intersection analysis system 300 (e.g., the database 380, the mission control 370, the sensor rig 350, and/or the vehicle 302). In various embodiments described here, the one or more processors of the sensor rig 350 execute the various models and simulations. However, it should be understood that any of the components of the intersection analysis system 300 may execute the various simulations and models. The intersection entrance simulation may include a simulation with inputs from the database 380, the mission control, 370, the sensor rig 350, and/or the truck 302. In one embodiment, the intersection entrance simulation simulates the entrance of the truck 302 into an entrance associated with the sensor rig 350. For example, the simulation may be stored in the database 380 but be executed on one or more of the mission control 370, the sensor rig 350, and/or the truck 302. The simulation can use the data collected/perceived by the various systems and modules of the sensor rig 350 and the truck 302 to determine an entrance opportunity and an associated safety factor. This simulation can be executed in real time to present to the mission control 370 when a certain safety factor threshold is reached. For example, the sensor rig 350 may scan the associated intersection and provide the data into the simulation to determine when a safe opening is available for the truck 302 to enter the intersection (e.g., an entrance event). Once an entrance opportunity is available with a sufficiently high safety factor, the sensor rig 350 (or truck 302) transmits an alert to the mission control 370 with a request to approve the entrance event. By approving the entrance event at the mission control 370, the approval is transmitted back to the sensor rig 350 and/or the truck 302. Upon receiving approval, the sensor rig 350 may relay the approval to the truck 302, and the truck 302 proceeds to execute the simulated entrance event. In some embodiments, the entrance event takes into account the delay between executing the simulation, receiving approval, and executing the entrance event. In other words, the simulation can take into account the movement of objects perceived by the sensor rig 350 and forecast future position and movement when determining a safety factor and/or entrance event for which approval is sought. For example, an entrance event with a sufficiently high safety factor at a singular instant may not be transmitted for approval to the mission control 370 if by the time an approval is received the safety factor is predicted to be too low, even if at the moment the simulation was executed it was high enough. In some embodiments, the entrance event is simulated in the future and takes into account the delay for approval and running the simulation.

The database 380 can store historical data of the sensor rig 350 to continually update the simulations and models. For example, the sensor rig 350 may continue to perceive the intersection environment during an executed entrance event by the truck 302. In executing the entrance event, objects perceived in the intersection may alter course of trajectory (e.g., speed and/or direction). Over time, the database 380 may collect sufficient data to be able to accurately predict future actions by vehicles, pedestrians, animals, bicyclists, etc. during an entrance event. This collected traffic data may be transmitted and averaged over time and location from various sensor rigs 350. Alternatively, or in addition, this collected data may be used for individualized simulations for specific intersections (e.g., the simulation may take into account specific vehicles that drive through the intersection by perceiving a specific driver's actions over time). Thus, the intersection entrance simulation may be improved over time. As with various simulations and models described herein, the intersection entrance simulation may also take into account road conditions present at the associated intersection (e.g., wet/slippery roads, increased traction from varying temperatures, etc.).

The database may also store an intersection exit simulation. Similar to the intersection entrance simulation, the sensor rig 350 perceives the environment surrounding and within the associated intersection. This perceived data is then input into the simulation stored in the database 380 and/or the sensor rig 350. The simulation simulates various exit events and, upon an associated safety factor reaching a threshold, transmits the simulated exit event to the mission control 370 to request approval to execute the exit event. Upon receiving approval to execute the exit event from the mission control 370, the sensor rig 350 relays the approval to the truck 302 to execute the exit event. The exit event may correspond to a path that the vehicle 302 may take to exit an intersection to enter into a hub, continue on a road, exit a road, etc.

The safety factor generated for each exit/entrance event generated in the intersection exit/entrance simulations may be associated with a safety or danger of executing an entrance/exit event. In one embodiment, it is a measure of the probability of the vehicle executing the entrance/exit event safely. The simulation may require a certain threshold of the safety factor to be reached prior to requesting approval to execute. For example, the simulation may require a 99% chance of safely executing the entrance event (e.g., entering the intersection without resulting in an unanticipated collision with a foreign object or causing an unsafe intersection event) prior to sending for approval. The safety factor may be higher or lower than 99%. The safety factor may be calculated/generated by using various methods and techniques and using various inputs from the database 380, the sensor rig 350, and/or the vehicle 302 (e.g., predicted location/speed of objects in the intersection, predicted path of the truck 302, operational parameters and capabilities of the truck 302, date, weather, time, known object data, mission control 370 personnel, etc.).

Once an exit event and associated safety factor is generated, it is transmitted to the mission control 370. In some embodiments, the operator in receipt of the request for approval may see the proposed exit event and corresponding safety factor in order for the operator to make an approval determination. In other embodiments, the safety factor is not displayed. In some embodiments, once the initial alert to the mission control 370 is made, the operator is provided with a display of perception data from the sensor rig 350 (e.g., image data) and simulated entrance/exit events with corresponding safety factors, all updated in real time.

In addition to simulations, the database 380 may store various models, including an autonomous vehicle hub viability model and a traffic light placement model. In an exemplary autonomous vehicle hub viability model, the sensor rig 350 may execute a model to determine the viability of a vehicle hub placement proximate the sensor rig 350. In some embodiments, the sensor rig 350 may be placed along a road to perceive the traffic conditions of the road overtime. This perceived traffic data may be sent to be stored in the database 380, or used by the sensor rig 350 to execute the autonomous vehicle hub viability model (or other simulations/models). The perceived data may include traffic amount, traffic type, visibility, road usage, etc. In some embodiments the autonomous vehicle hub viability model may be executed on the Mission Control 370 computing device.

The sensor rig 350 need not be placed at an intersection to execute the autonomous vehicle hub viability model. Indeed, the autonomous vehicle hub viability model may be used to determine the viability of an intersection placement at or near the placement of the sensor rig 350. The autonomous vehicle hub viability model may use the simulations described herein to simulate the frequency of available entrance and/or exit events at a certain location based on the perceived traffic conditions therein. This model may allow an accurate and cost-effective method of determining the viability of a placement of an autonomous vehicle hub by perceiving the conditions there over time using sensors and equipment that may be found on the autonomous vehicles used at the autonomous vehicle hub. In some embodiments the sensor rig may be a portable sensor rig such as the portable sensor rig 450B of FIG. 4B. By using the sensor rig 350 to collect data to input into the autonomous vehicle hub viability model, the model may be used to determine the viability of a hub intersection not only at the placement of the sensor rig 350, but also at locations within the range of the perception of the sensor rig 350. This may allow the sensor rig 350 to determine the viability of multiple locations at once with only one sensor rig 350.

As described herein, the autonomous vehicle hub viability model stored in database 380 may be executed by the sensor rig 350 with the collected data from the sensor rig 350 and the generated simulated entrance and exit events of the simulations described herein (based on the perceived traffic data described herein).

In addition to the autonomous vehicle hub viability model, the database 380 may also house a traffic light placement model. The traffic light placement model may be used to determine the need for a traffic light at a location at or near the placement of a sensor rig 350. The sensor rig 350 may simulate the effects of a traffic light on an intersection or proposed intersection to help government and localities determine the need for a traffic light. According to some embodiments, the traffic light placement model may collect and perceive data associated with the intersection (for example, traffic conditions over time) and then retroactively apply a simulation of a traffic light to the collected and perceived data to determine the effects of the proposed traffic light on the collected traffic data. In some embodiments the traffic light placement model may simulate the actions of the various perceived objects in the intersection based on the existence of a traffic light any effects produced thereon to the intersection.

The sensor rig 350 may also be used as a stopgap for an intersection during the process of approving and installing a traffic light at an intersection.

The sensor rig 350 provides an advantage over traditional traffic sensing equipment such as piezoelectric sensing equipment because the embodiments disclosed herein do not present tripping hazards for pedestrians and bicyclists, higher fidelity information can be gathered, and new vehicle 302 sensor equipment may be tested.

Turning now to FIG. 4A, a permanent sensor rig 450A is illustrated. The permanent sensor rig 450A may include a vertical mast 406A, a sensor suite 402A, and one or more sensors/modules 404A. The various sensors/modules 404A housed in the sensor suite 402A are described in greater detail in FIG. 3. Though shown at the top of the vertical mast 406A, the sensor suite 402A may be located at any position on the sensor rig 450A. Additionally, the various sensors and modules 404A of the sensor suite 402A may be placed at any position on the sensor rig 450A and need not be placed in proximity to each other as illustrated in FIG. 4A.

The vertical mast 406A of the permanent sensor rig 450A may be placed in the ground so as to provide a solid foundation for the sensor rig 450A. A bottom portion of the vertical mast 406 a may be placed in concrete or any other suitable foundation. The permanent sensor rig 450A may include a power source to provide power to the various electronics housed on the sensor rig 450A (e.g., sensors, modules, transceivers, lights, etc.). The power may be provided by extrinsic means (e.g., a power grid) and/or by intrinsic means (a fuel generator, solar power, wind power, hydrogen power, hydropower, etc.). In some embodiments, the permanent sensor rig 450A may include a battery to preserve functionality of the permanent sensor rig 450A during a lapse in power input/generation.

Turning now to FIG. 4B, a portable sensor rig 450B is shown. As with the permanent sensor rig 450A, the portable sensor rig 450B may include a vertical mast 406B, a sensor suite 402B, and one or more sensors/modules. In addition, the portable sensor rig 450B may include a base 408B and one or more tractive elements 410B (e.g., wheels, tracks, etc.). In some embodiments the base 408B may include power generation sources such as a fuel generator, solar power, wind power, hydrogen power, hydropower, power grid hookup, etc. In addition, the portable sensor rig 450B may provide for means to transport the portable sensor rig 450B. For example, the portable sensor rig 450B may include a tow hitch or other means for pushing or pulling the portable sensor rig 450B. Alternatively, or in addition, the portable sensor rig 450B may independently move through means of a prime mover (electric motor, gasoline-powered engine, diesel-powered engine, hydrogen-powered engine). In some embodiments, the base 408B may include a battery to preserve functionality of the portable sensor rig 450B during a lapse in power input/generation.

Though not necessary for all embodiments to have all the advantages disclosed herein, one advantage of an embodiment of FIGS. 4A-4B is the ability to test sensors and modules for use in future autonomous vehicles. For example, in developing and researching new sensors, sensor placements, or sensor software, the developed products and features may be implemented in a controlled real-world environment to determine viability and success of the sensors and associated developments. This allows for new technology to be tested alongside known products in real-time, real-world scenarios without the risk of damage to a vehicle (e.g., truck 302). In some embodiments, the sensor suite 402A/402B may have reconfigurable positions for the various housed sensors and modules. For example, the sensors may be easily removed and replaced with different sensors/modules using mechanical (bolts, nails, screws, adhesives, friction, compliant mechanism, etc.) and electrical fasteners/connections (e.g., plugs, pins, receivers, etc.).

Another advantage of the sensor rig embodiment is the ability to use a single sensor suite 402A for any autonomous vehicle entering/exiting an intersection. In some embodiments, a fleet of trucks 302 may only travel between autonomous vehicle hubs. Thus, the truck(s) 302 may only need to enter and exit a specific and known set of intersections. Thus, the sensor rig 450A, 450B may be placed at each known intersection to avoid needing to outfit each truck 302 with additional sensors for the sole purpose of entering and exiting an intersection. In so doing, costs are saved.

### Description of Intersection Analysis Implementation at Existing Intersection

Turning now to FIG. 5A, an exemplary implementation of the intersection analysis system 300 of FIG. 3 at an existing intersection is illustrated.

An intersection analysis system 500 is shown implemented in FIG. 5A, with a truck 502A (e.g., the truck 102 of FIG. 1) stopped at an intersection 540A, a sensor rig 550A (e.g., permanent sensor rig 450A of FIG. 4A or portable sensor rig 450B of FIG. 4B), a first vehicle 502A travelling in a direction 503A, a second vehicle 504A travelling in a direction 505A, and a control center 570A (e.g., a remote control center or a local control center).

In an exemplary embodiment, the truck 502A is arriving at the intersection 540A from an autonomous vehicle hub 501A. The truck 502A must turn onto a road 520A to exit the autonomous vehicle hub 501A. In an exemplary embodiment, the truck 502A must make a left-hand turn onto the road 520A. Upon the truck 502A arriving at the intersection 540A, the sensor rig 550A senses through its various modules and sensors (e.g., the perception module, the camera system, the LiDAR system, the radar system, the sonar system, etc.) the presence of the truck 502A. The sensor rig 550A then transmits an indication of the presence of the truck 502A to the mission control 570A. In some embodiments, the sensor rig 550A alerts the mission control 570A of the presence of the truck 502A as the truck 502A approaches the intersection 540A.

In alerting the mission control 570A, the operator of a computing device of mission control 570A is alerted to ensure a supervisor is available to respond to an impending approval request from the sensor rig 550A. The sensor rig 550A continues to scan the intersection 540A with its various modules and sensors. In scanning the intersection 540A, the sensor rig 550A is collecting data to input into the intersection entrance simulation. The intersection entrance simulation is a program that simulates the truck's 502A entrance into the intersection 540A along various entrance paths (e.g., entrance path 544A). In determining the entrance path 544A, the sensor rig 550A first identifies possible drivable surfaces (e.g., a drivable surface 542A) on which the truck 502A may travel. The drivable surface 542A, in some embodiments, is an area in which the truck 502A may travel legally and without causing a collision or other unsafe situation (e.g., causing another user of the road 520A to drive off the road, slam on brakes, veer out of control, excessively alter a travelled course, etc.). As such, there exists limited drivable surfaces within the intersection 540A. For example, the non-drivable surfaces 546A depict areas within the intersection of 540A on which the truck 502A may not legally drive or travel without causing a collision or other unsafe situation (e.g., driving off the road, driving on the wrong side of the road, crashing into another vehicle). Once the sensor rig 550A identifies the drivable surface 542A on which to execute the entrance path 544A, the sensor rig 550A generates a safety factor corresponding to the identified entrance path. In some embodiments, the intersection entrance simulation does not generate a safety factor. Once an entrance path has been identified by the sensor rig 550A executing the entrance simulation, the sensor rig 550A transmits the identified entrance path 544A to the mission control 570A. The sensor rig 550A requests approval by the Mission Control 570A for the truck 502A to execute an entrance event following the entrance path 544A transmitted to the mission control 570A. In embodiments in which a safety factor is generated by the intersection entrance simulation, the entrance path 544A may only be transmitted to the mission control 570A upon the safety factor reaching a predetermined threshold. In other embodiments, every entrance path determined by the sensor rig 550A is transmitted to the mission control 570A and the approval to execute the entrance path is only requested upon the safety factor satisfying a predetermined threshold. The mission control 570A may be operated by a human supervisor or maybe a computer program executed without human operation. In some embodiments, the sensor rig 550A may transmit multiple entrance paths 544A with a ranking based on one or more parameters (e.g., safety factor, speed, length, time of generation, etc.). In this embodiment, the mission control 570A may select from the list of possible entrance paths to execute.

Upon receiving the request for approval from the sensor rig 550A, the operator of the mission control 570A determines to approve or deny the entrance event for the truck 502A. This approval or denial is transmitted back to the sensor rig 550A. In the event that the mission control 570A responds with approval, the sensor rig 550A transmits a communication to the truck 502A to initiate the entrance event along path 544A over the drivable surface 542A. In this embodiment the sensor rig 550A transmits both the approval and the path 544A.

Upon receiving the indication of approval from the sensor rig 550A, the truck 502A initiates the entrance event along the entrance path 544A over the drivable surface 542A using the methods and techniques described herein, specifically in FIGS. 1-2. In some embodiments, the sensor rig 550A transmits a control signal to control the truck 502A directly to initiate the entrance event following the entrance path 544A.

In the event that the mission control 570A transmits a denial of the entrance event to sensor rig 550A, the sensor rig 550A may transmit the indication of denial to the truck 502A. Upon receiving the indication of denial from the sensor rig 550A, the truck 502A remains at the entrance of the intersection 540A and does not initiate the entrance event. In other embodiments, the sensor rig 550A transmits nothing to the truck 502A in response to receiving an indication of denial from the mission control 570A.

In some embodiments the intersection entrance simulation takes into account the position and direction of travel of various objects present in the intersection 540A, or that may be present in the intersection 540A. For example, the intersection entrance simulation may take into account the position of the vehicle 502A traveling in the direction 503A. The intersection entrance simulation may also take into account the position of vehicle 504A traveling in the direction of 505A. The simulation may forecast future positions and directions of travel of the objects based on perceived data from the sensor rig 550A and historical data from a database (e.g., the database 380 of FIG. 3). For example, the simulation may take into account the presence of a blinker on the vehicle for 502A or a deceleration of the vehicle 504A. The intersection entrance simulation may take these dynamic parameters and input them into the simulation to make predictions of future actions of objects in or near the intersection 540A to create more accurate proposed entrance paths 544A. In some embodiments, the sensor rig 550A receives perception data from the area surrounding the intersection 540A and uses this information in the intersection entrance simulation to further increase the accuracy in generating entrance paths 544A and the associated safety factors. In some embodiments the mission control 570A, though illustrated remotely, may be stored locally to the sensor rig 550A and/or the truck 502A.

In some embodiments the mission control 570A is not required in implementing the intersection analysis system 500A. For example, the sensor rig 550A may make the determination whether or not to initiate the entrance event along entrance path 544A without the approval of the mission control 570A.

### Description Intersection Analysis System Implementation for Simulation

Turning now to FIG. 5B, an exemplary implementation of the intersection analysis system 300 of FIG. 3 for simulating a proposed intersection is illustrated.

An intersection analysis system 500B is illustrated. The intersection analysis system 500B includes a sensor rig 550B. In some embodiments the sensor rig 550B is a portable sensor rig such as the portable sensor rig 450B of FIG. 4B.

According to an exemplary embodiment, the sensor rig 550B is located and or near the position of a proposed autonomous vehicle hub location 501B. In the exemplary embodiment illustrated in FIG. 5B, the sensor rig 550B is positioned at or near the proposed autonomous vehicle hub location to determine the viability of developing the proposed autonomous vehicle hub. The sensor rig 550B may be configured to execute one or more simulations and models to determine the viability of the proposed autonomous vehicle hub 501B. For example, the sensor rig 550B may execute an autonomous vehicle hub viability model (as described in FIG. 3) to simulate the impact of the proposed autonomous vehicle hub 501B on the existing road 520B and the proposed intersection 540B.

In executing the autonomous vehicle hub viability model, the sensor rig 550B may utilize perceived traffic and environment data collected from the area at or near the location of the sensor rig 550B. This data may be used in executing the autonomous vehicle hub viability model to simulate the entrance and exit of one or more simulated truck(s) 502B and the resulting effect on traffic. For example, the sensor rig 550B may perceive and collect data on a vehicle 504B traveling in a direction 505B and also collect data on vehicle 502B traveling in the direction of 503B. As in the methods and techniques described in FIG. 5A, the autonomous vehicle hub viability model executed by the sensor rig 550B may generate simulations of various paths and drivable surfaces for the simulated truck 502B to travel on. For example, the autonomous vehicle hub viability model may generate a simulated entrance path 544B over a simulated drivable surface 542B. The autonomous vehicle hub viability model may then execute simulations based on collected traffic and environmental data to determine the effect on traffic of the simulated truck 502B executing an entrance event along the simulated entrance path 544B over simulated drivable surface 542B. In addition, the autonomous vehicle viability model may determine the frequency at which entrance paths are available at the location associated with the sensory 550B.

In some embodiments the autonomous vehicle hub viability model may output a viability score for a particular location associated with the proposed autonomous vehicle hub location. The viability score may be determined based on a variety of factors including, but not limited to, the frequency of entrance paths available at the location, the traffic conditions at the location, the safety factors associated with the simulated entrance paths, and environmental conditions (e.g., road conditions, visibility conditions, climate/weather conditions, etc.). Decision makers (or trained algorithms) may use the viability score to make a determination on whether or not to advance with developing the proposed autonomous vehicle hub 501B. In some embodiments the sensor rig 550B may determine a viability score for various locations within the perception area of the sensor rig 550B to determine an optimal location of the proposed autonomous vehicle hub. For example, a location near a traffic signal may be a better or worse location for the proposed autonomous vehicle hub based on traffic conditions near the traffic signal. According to an embodiment, the sensor rig 550B may transmit the outputs of the autonomous vehicle hub viability model (e.g., the viability score and or simulation data) to a mission control or other device through a network (e.g., the network 360 of FIG. 3).

FIG. 6 is a flowchart of an example method 600 for directing an autonomous vehicle to safely enter an intersection, such as illustrated in FIG. 5A. According to an exemplary embodiment, one or more processors are configured to perform the following steps. At step 610, receive from one or more sensors, an indication of a presence of an autonomous vehicle at a drivable intersection (e.g., at an entrance) associated with the sensor apparatus. At step 620, alert a supervisory computing device (e.g., a mission control) of the presence of the autonomous vehicle at the drivable intersection. At step 630, receive from the one or more sensors, a signal associated with a drivable area (a surface on which the vehicle may legally, and safely, travel) on which the autonomous vehicle may travel. At step 640, predict a drivable path (e.g., an entrance path) for the autonomous vehicle entering the drivable intersection. At step 650, transmit to a supervisory module (e.g., a remote or local mission control), an indication of the drivable path. At step 660, request from the supervisory computing device, an approval for the autonomous vehicle to adjust an operating parameter (e.g., a speed, steering angle, light indicator, etc.) to travel on the drivable path in view of other vehicles at the drivable intersection. At step 670, receive from the supervisory computing device (e.g., operated by a supervisor), the approval to adjust the operating parameter to travel on the drivable path. At step 680, upon receiving the approval, transmit to an electronic control unit of the autonomous vehicle, a control signal to adjust the operating parameter to initiate travelling on the drivable path.

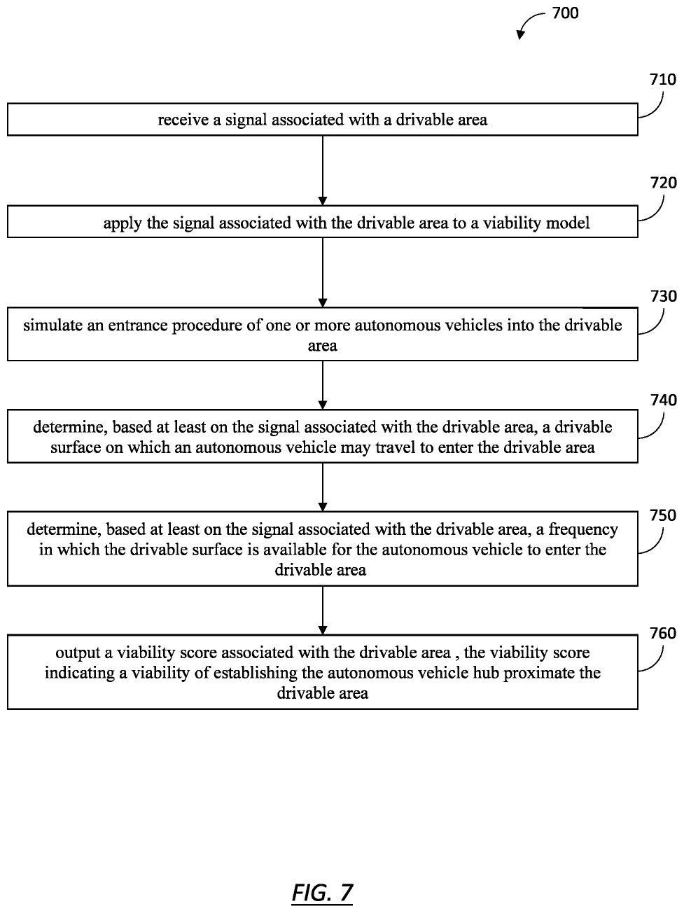

FIG. 7 is a flowchart of an example method 700 for determining the viability of a future autonomous vehicle hub, such as illustrated in FIG. 5B. According to an exemplary embodiment, one or more processors are configured to perform the following steps. At step 710, receive a signal (e.g., perception data) associated with a drivable area (e.g., an intersection). At step 720, apply the signal associated with the drivable area to a viability model (e.g., the autonomous vehicle hub model of FIG. 5B). At step 730, simulate an entrance procedure (e.g., an entrance event) of one or more autonomous vehicles into the drivable area. At step 740, determine, based at least on the signal associated with the drivable area, a drivable surface (an entrance path on which an autonomous vehicle may safely travel to enter the drivable area). At step 750, determine, based at least on the signal associated with the drivable area, a frequency in which the drivable surface is available for the autonomous vehicle to enter the drivable area (e.g., how often an autonomous vehicle may enter the intersection based on the collected data). At step 760, output a viability score associated with the drivable area, the viability score indicating a viability of establishing the autonomous vehicle hub proximate the drivable area.

It is to be understood that the method 600, 700 is not limited to the steps and features explicitly listed therein and that modifications including additional or fewer steps and/or features are within the scope of the various embodiments described herein. The systems and methods described herein may be used for both aiding an autonomous vehicle safely navigate an intersection and determine the viability of a location being used as an autonomous vehicle hub.

It should now be understood that image data (e.g., camera data and/or LiDAR data) obtained by one or more sensor rigs in a fleet of sensor rigs can be captured, recorded, stored, and labeled with ground truth location data for use to train an intersection analysis system to detect, classify, and respond to real time image data captured by a sensor rig using a camera or LiDAR system and presenting the captured real time image data to the machine learning model(s). Use of such models may significantly reduce computational requirements aboard a fleet of vehicles utilizing the method(s) and may make the vehicles more robust to meeting location-based and perception requirements, such as localization and behaviors planning and mission control.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system comprising:
a supervisory computing device; and
a sensor apparatus positioned at a drivable intersection, the sensor apparatus remote from an autonomous vehicle and in communication with the autonomous vehicle and comprising:
one or more sensors configured to receive a sensor signal associated with the drivable intersection; and
one or more processors configured to:
receive, from the one or more sensors, an indication of a presence of the autonomous vehicle at the drivable intersection associated with the sensor apparatus;
alert the supervisory computing device of the presence of the autonomous vehicle at the drivable intersection;
receive, from the one or more sensors, a signal associated with a drivable area on which the autonomous vehicle may travel;
predict a drivable path for the autonomous vehicle entering the drivable intersection;
transmit, to a supervisory module, an indication of the drivable path;
request, from the supervisory computing device, an approval for the autonomous vehicle to adjust an operating parameter to travel on the drivable path in view of other vehicles at the drivable intersection;
receive, from the supervisory computing device, the approval to adjust the operating parameter to travel on the drivable path; and
upon receiving the approval, transmit to an electronic control unit of the autonomous vehicle, a control signal to adjust the operating parameter to initiate travelling on the drivable path.

2. The system of claim 1, wherein the one or more sensors may be used on the autonomous vehicle.

3. The system of claim 1, wherein the sensor apparatus is permanently installed proximate the drivable intersection.

4. The system of claim 1, wherein the one or more sensors include at least one of a camera, a LiDAR sensor, a radar sensor, and a sonar sensor.

5. The system of claim 1, wherein the one or more processors predict the drivable path by inputting at least the signal associated with the drivable area into a simulation model.

6. The system of claim 1, wherein the supervisory computing device is located at a mission control headquarters remote to the sensor apparatus and the autonomous vehicle and operated by a user.

7. The system of claim 1, wherein the sensor apparatus is used for testing new sensors for the autonomous vehicle.

8. A sensor apparatus positioned at a drivable intersection, the sensor apparatus remote from an autonomous vehicle and in communication with the autonomous vehicle and comprising:
one or more sensors configured to receive a sensor signal associated with the drivable intersection; and
one or more processors configured to:
receive, from the one or more sensors, an indication of a presence of the autonomous vehicle at the drivable intersection associated with the sensor apparatus;
alert a supervisory computing device of the presence of the autonomous vehicle at the drivable intersection;
receive, from the one or more sensors, a signal associated with a drivable area on which the autonomous vehicle may travel;
predict a drivable path for the autonomous vehicle entering the drivable intersection;
transmit, to a supervisory module, an indication of the drivable path;
request, from the supervisory computing device, an approval for the autonomous vehicle to adjust an operating parameter to travel on the drivable path in view of other vehicles at the drivable intersection;
receive, from the supervisory computing device, the approval to adjust the operating parameter to travel on the drivable path; and
upon receiving the approval, transmit to an electronic control unit of the autonomous vehicle, a control signal to adjust the operating parameter to initiate travelling on the drivable path.

9. The sensor apparatus of claim 8, wherein the one or more sensors may be used on the autonomous vehicle.

10. The sensor apparatus of claim 8, wherein the sensor apparatus is permanently installed proximate the drivable intersection.

11. The sensor apparatus of claim 8, wherein the one or more sensors include at least one of a camera, a LiDAR sensor, a radar sensor, and a sonar sensor.

12. The sensor apparatus of claim 8, wherein the one or more processors predict the drivable path by inputting at least the signal associated with the drivable area into a simulation model.

13. The sensor apparatus of claim 8, wherein the supervisory computing device is located at a mission control headquarters remote to the sensor apparatus and the autonomous vehicle and operated by a user.

14. The sensor apparatus of claim 8, wherein the sensor apparatus is used for testing new sensors for the autonomous vehicle.

15. A computer-implemented method comprising:
receiving, by one or more processors of a sensor apparatus, from one or more sensors, an indication of a presence of an autonomous vehicle at a drivable intersection associated with the sensor apparatus;
alerting, by the one or more processors, a supervisory computing device of the presence of the autonomous vehicle at the drivable intersection;
receiving, by the one or more processors, from the one or more sensors, a signal associated with a drivable area on which the autonomous vehicle may travel;
predicting, by the one or more processors, a drivable path for the autonomous vehicle entering the drivable intersection;
transmitting, by the one or more processors, to a supervisory module, an indication of the drivable path;
requesting, by the one or more processors, from the supervisory computing device, an approval for the autonomous vehicle to adjust an operating parameter to travel on the drivable path in view of other vehicles at the drivable intersection;
receiving, by the one or more processors, from the supervisory computing device, the approval to adjust the operating parameter to travel on the drivable path; and
upon receiving the approval, transmitting, by the one or more processors, to an electronic control unit of the autonomous vehicle, a control signal to adjust the operating parameter to initiate travelling on the drivable path.

16. The method of claim 15, wherein the sensor apparatus is permanently installed proximate the drivable intersection.

17. The method of claim 15, wherein the one or more sensors include at least one of a camera, a LiDAR sensor, a radar sensor, and a sonar sensor.

18. The method of claim 15, wherein the one or more processors predict the drivable path by inputting at least the signal associated with the drivable area into a simulation model.

19. The method of claim 15, wherein the supervisory computing device is located at a mission control headquarters remote to the sensor apparatus and the autonomous vehicle and operated by a user.

20. The method of claim 15, wherein the sensor apparatus is used for testing new sensors for the autonomous vehicle.
